(19) United States
(12) Patent Application Publication
(10) Pub. No.: US 2010/0061570 A1
(43) Pub. Date: Mar. 11, 2010

(54) COMMUNICATION DEVICE

(75) Inventor: HSIN-TIEN LO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/411,358

(22) Filed: Mar. 25, 2009

(30) Foreign Application Priority Data
Sep. 9, 2008 (CN) 200820302055.8

(51) Int. Cl. H04R 3/00

(52) U.S. Cl. 381/122

(57) ABSTRACT

A communication device includes a circuit board including a plurality of contact pads and a microphone. The microphone includes a cell, a cylindrical cap contoured to define a receiving space receiving the cell, a protecting ring extending along a periphery of a bottom portion of the cylindrical cap, and a plurality of contact posts positioned on the bottom portion and contacting the plurality of contact pads to electrically connecting the circuit board and the microphone. The cylindrical cap, the protecting ring, and the contact posts are integrally formed. A height of the protecting ring is greater than that of each of the contact posts such that the protecting ring surrounds the contact pads and the contact posts to protect the microphone from dust.

### BACKGROUND

1. Technical Field

The present disclosure generally relates to communication devices, and more particularly to a communication device with a protecting ring.

2. Description of Related Art

In a voice communication device, a microphone and a speaker must be provided in order to allow a user to send and receive audio signals with another compatible device used by another person. However, the electrical connection between the microphone and a circuit board may be broken if a junction between the microphone and the circuit board fills with dust.

Therefore, a need exists in the industry to overcome the described limitations.

### BRIEF DESCRIPTION OF THE DRAWINGS

FIG. 1 is an exploded, isometric view of a communication device of an exemplary embodiment of the disclosure; and

FIG. 2 is a cross-sectional, inverted, assembled view of FIG. 1.

### DETAILED DESCRIPTION OF THE EMBODIMENTS

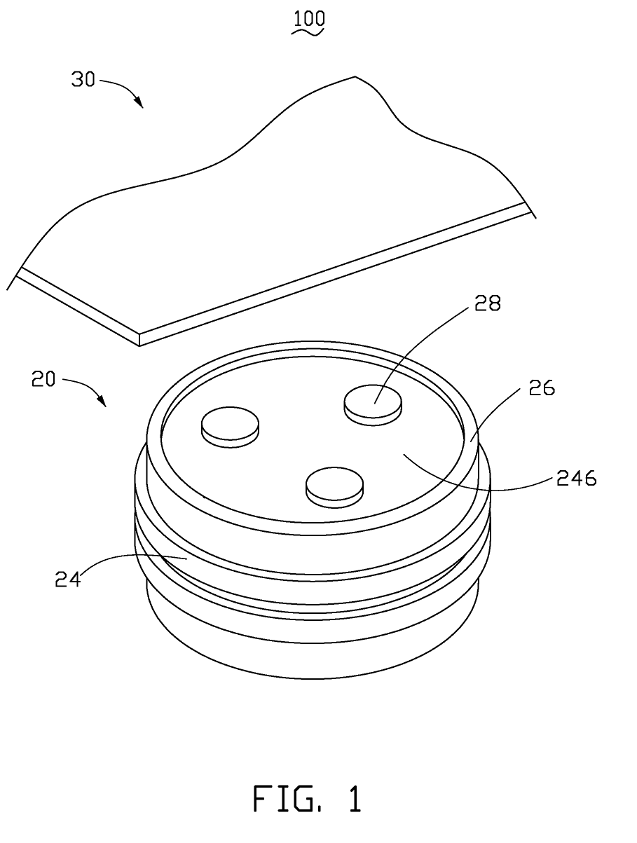

FIG. 1 is an exploded, isometric view of a communication device 100 of an exemplary embodiment of the present disclosure. The communication device 100 includes a microphone 20 and a circuit board 30.

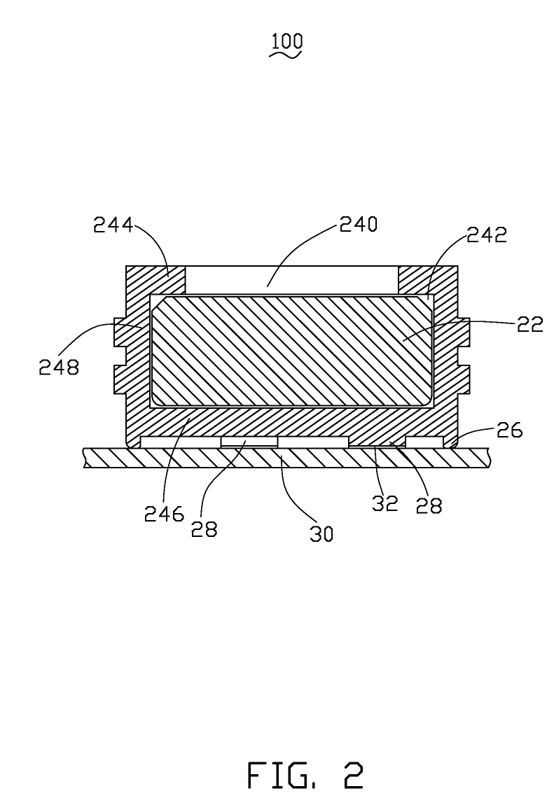

The circuit board 30 includes a plurality of contact pads 32 (shown in FIG. 2) for electrically connecting the circuit board 30 and the microphone 20.

Referring also to FIG. 2, the microphone 20 includes a cell 22, a cylindrical cap 24 configuring for receiving the cell 22, a protecting ring 26, and a plurality of contact posts 28 corresponding to the contact pads 32 of the circuit board 30. The cylindrical cap 24, the protecting ring 26, and the contact posts 28 are integrally formed.

The cylindrical cap 24 includes a receiving space 242 defined in the middle thereof, a bottom portion 246, a top portion 244, and a pair of side portions 248 connecting the bottom portion 246 and the top portion 244. The top portion 244, the bottom portion 246, and the side portions 248 bound the receiving space 242. The cell 22 is received in the receiving space 242. The top portion 244 defines a hole 240 communicating with the receiving space 242 in order to send and receive audio signals. The protecting ring 26 extends from along a periphery of the bottom portion 246. In the illustrated embodiment, the protecting ring 26 and the cylindrical cap 24 are made of conductive rubber. Alternatively, the protecting ring 26 and the cylindrical cap 24 may be made of other conductive materials.

The contact posts 28 project from a surface of the bottom portion 246 contacting the contact pads 32 to electrically connect the microphone 20 and the circuit board 30. A height of each of the contact posts 28 is less than that of the protecting ring 26 on the cylindrical cap 24.

In assembly, the cell 22 is received in receiving space 242 of the cylindrical cap 24. The microphone 20 is attached to the circuit board 30 so that the microphone 20 and the circuit board 30 are assembled in the communication device 100. In this position, the contact posts 28 of the microphone 20 are electrically connected to the contact pads 32 of the circuit board 30. The protecting ring 26 surround the pad 32 and the contact posts 28.

Because the protecting ring 26 is made of rubber, there are no gaps between the microphone 20 and the circuit board 30 after assembly, as a result, the microphone 20 is protected from dust.

Because the protecting ring 26 surrounds the pad 32 and the contact posts 28, the junction between the contact posts 28 and the contact pads 32 is prevented from collecting dust, as a result, the contact posts 28 of the microphone 20 can maintain electrically connected to the contact pads 32 of the circuit board 30.

While an embodiment of the present disclosure has been described, it should be understood that it has been presented by way of example only and not by way of limitation. Thus the breadth and scope of the present disclosure should not be limited by the above-described exemplary embodiments, but should be defined only in accordance with the following claims and their equivalents.

What is claimed is:

1. A communication device comprising:
a circuit board comprising a plurality of contact pads; and
a microphone comprising a cell, a cylindrical cap contoured to define a receiving space for receiving the cell, a protecting ring extending along a periphery of a bottom portion of the cylindrical cap, and a plurality of contact posts positioned on the bottom portion and contacting the plurality of contact pads to electrically connect the circuit board and the microphone, wherein the cylindrical cap, the protecting ring, and the contact posts are integrally formed;
wherein a height of the protecting ring is greater than that of each of the contact posts such that the protecting ring surrounds the contact pads and the contact posts to protect the microphone from dust.

2. The communication device as claimed in claim 1, wherein the protecting ring and the cylindrical cap are made of conductive rubber.

3. The communication device as claimed in claim 3, wherein a hole is defined in a top portion of the cylindrical cap for communication with the receiving portion to send and receive audio signals.

4. The communication device as claimed in claim 3, wherein the contact posts project from a surface of the bottom portion.
